(19) United States
(12) Patent Application Publication
(10) Pub. No.: US 2025/0214263 A1
(43) Pub. Date: Jul. 3, 2025

(54) ROBOT ASSEMBLY FOR PROCESSING AND/OR HANDLING A WORKPIECE, PROTECTION ELEMENT FOR A ROBOT ASSEMBLY, AND PROTECTION ASSEMBLY

(71) Applicant: ROUNDPEG TECHNOLOGIES GMBH, Aschheim (DE)

(72) Inventors: Oliver KRIEG, Aschheim (DE); Etienne EICHSTAEDT, Aschheim (DE); Hermann WIESER, Aschheim (DE)

(21) Appl. No.: 18/848,340

(22) PCT Filed: Mar. 18, 2022
(86) PCT No.: PCT/EP2022/057192

§ 371 Date: Sep. 18, 2024

(51) Int. Cl. B25J 19/00; B25J 9/16; B25J 13/08

(52) U.S. Cl. CPC B25J 19/0075; B25J 9/1676; B25J 13/088

(57) ABSTRACT

A robot assembly for processing and/or handling a workpiece is described. It comprises a manipulator unit with a flange surface, an effector unit which is mounted on the flange surface, and a protection element which is fastened to the manipulator unit and/or to the effector unit. The protection element has an extension component along a flange surface central axis and is positioned at least in portions next to the effector unit in the flange surface in the transverse direction. Furthermore, a fastening interface for fastening a sensor unit is provided on the protection element for collision protection. Alternatively, the protection element can be monitored by sensors for collision protection. A protection element for such a robot assembly is also presented. Also presented is a protection assembly comprising such a protection element and a distance sensor unit.

The invention relates to a robot assembly for processing and/or handling a workpiece. The robot assembly comprises a manipulator unit having a flange surface, wherein a flange surface central axis is perpendicular to the flange surface, and a flange surface transverse direction extends in parallel with the flange surface. In addition, the robot assembly has an effector unit which is mounted on the flange surface and has an extension component along the flange surface central axis as well as an extension component in the flange surface transverse direction.

The invention is also directed to a protection element for such a robot assembly.

The invention also relates to a protection assembly having such a protection element.

In this regard, the flange surface central axis and the flange surface transverse direction are defined in such a manner as to intersect. The flange surface central axis and the flange surface transverse direction are thus not skew. Furthermore, the flange surface transverse direction and the flange surface central axis are perpendicular to one another.

Numerous applications of robot assemblies make provision for the robot assembly to share its working space with people. This is the case e.g. in the context of human-robot cooperation. In such cases, it must be ensured that the people present within the working space of the robot assembly remain safe. Moreover, collisions between the robot assembly and components thereof and other non-human objects in the working space must be avoided. For this purpose, it is known to equip robot assemblies with corresponding sensor units which are designed to detect distances to people and non-human objects. Based on this, a movement of the robot assembly can be slowed down, changed in direction, stopped or prevented entirely.

It is necessary for the manipulator unit, the effector unit and any workpiece which may be coupled to the effector unit to avoid collisions. In this context, the manipulator unit is understood to mean a programmable apparatus, by means of which the flange surface can be positioned in the desired manner in space. For example, the manipulator unit is designed as a robot arm. The effector unit is understood to be an assembly which is designed to interact with the workpiece to be processed and/or handled. For example, the effector unit can be designed as a gripper unit or as a tool unit.

The above-mentioned collision protection of the robot assembly, i.e. the avoidance of collisions between the robot assembly and people or objects, is particularly challenging in operating situations in which the effector unit enters into interaction with a workpiece or ends an interaction with the workpiece, because it is necessary to reliably distinguish between desired interactions and undesired collisions.

Therefore, it is the object of the present invention to provide a robot assembly which offers reliable collision protection even in such situations.

The object is achieved by means of a robot assembly of the type mentioned in the introduction, which comprises a protection element which is fastened to the manipulator unit and/or the effector unit. The protection element has an extension component along the flange surface central axis and is positioned at least in portions next to the effector unit in the flange surface transverse direction. Moreover, a fastening interface for fastening a sensor unit is provided on the protection element for collision protection. Alternatively, the protection element can be monitored by sensors for collision protection. The protection element thus extends at least in part radially outside at least one portion of the effector unit in relation to the flange surface central axis. It can also be said that the protection element protrudes over at least part of the effector unit in relation to the flange surface. A portion of the protection element is always spaced apart from the effector unit. This applies in particular to an end of the protection element which is not fastened to the manipulator unit and/or the effector unit. This results in an exposed position of the fastening interface for fastening a sensor unit. Alternatively, this results in an exposed portion of the protection element which can be sensed indirectly or directly by sensors. Consequently, for the purpose of collision protection, the space around the effector unit can be monitored in particularly detailed and reliable manner by sensors. In particular, the arrangement of the protection element ensures that a portion surrounding the effector unit, which is arranged at an end of the effector unit opposite the flange surface, can be reliably monitored by sensors. The arrangement of the protection element means that there is little or no concealment of this surrounding portion by the effector unit. Therefore, when interacting with a workpiece, it is possible to distinguish precisely between the workpiece and other objects or a person. Furthermore, a workpiece picked up by the effector unit can also be reliably protected against collisions with a person or other objects by means of the protection element. Overall, the robot assembly together with any workpiece which may have been picked up can thus be reliably protected against undesired collisions.

Reference is made to the fact that, in addition to a sensor unit which can be fastened to the fastening interface of the protection element, further sensor units can also be provided which are mounted e.g. on the manipulator unit and/or on the effector unit. These can also serve to protect against collisions.

All sensor units are coupled by signal technology to a control unit of the robot assembly and so the robot assembly can be operated in dependence upon detection results determined by means of the sensor units.

Optionally, a sensor unit, fastened to the fastening interface, or the protection element monitored by sensors can also be used for tasks which go above and beyond collision protection. For example, the sensor unit and/or the protection element which is monitored by sensors can also be used for teaching certain points in the room. These can be points where interaction is to take place with a workpiece or the surrounding area. Furthermore, a surrounding area can be sensed by means of a sensor unit fastened to the fastening interface or by means of the protection element monitored by sensors, and this can be used to recalibrate the drive system and/or the position sensing system of the robot assembly in order to compensate for load-dependent or ageing-dependent influences.

In a preferred embodiment, an extension component of the protection element along the flange surface central axis is larger than an extension component of the protection element in the flange surface transverse direction. In such a configuration, the protection element thus extends comparatively far in the direction of an end of the effector unit facing away from the flange surface. Therefore, a sensor unit mounted on the fastening interface can be used to protect an area surrounding the effector unit, which is remote from the flange surface, in a particularly effective manner. The same applies if the protection element is monitored by sensors.

At least one distance sensor unit can be fastened to the fastening interface of the protection element, the sensing range of said distance sensor unit extending onto a side of the effector unit facing away from the flange surface. By means of such a distance sensor unit, it is possible to determine in particular distances of the effector unit from people or objects positioned on a side of the effector unit opposite the flange surface. To put it simply, such a distance sensor unit can look past the effector unit. A region of the area surrounding the effector unit can thus be monitored in a particularly effective manner, said region being located at an end of the effector unit facing away from the flange surface.

The distance sensor unit can be a distance sensor unit of a safety device according to international patent application PCT/EP2021/054849. The distance sensor unit can be coupled by signal technology to an evaluation unit of the safety device from international patent application PCT/EP2021/054849. Therefore, a method for determining a minimum distance according to international patent application PCT/EP2021/054849 can be used in order to determine distance by means of the distance sensor unit. In a first variant, in which the distance sensor unit is fastened to the fastening interface of the protection element, the method for determining a minimum distance can be carried out in such a way that a minimum distance between the distance sensor unit and a workpiece, an object and/or a person in the area surrounding the robot assembly are or will be determined. In a second variant, in which the protection element can be monitored by sensors for collision protection, the distance sensor unit can be positioned on the manipulator unit or the effector unit and the method for determining a minimum distance can be carried out in such a way that a minimum distance between the distance sensor unit and the protection element is determined.

Regarding the method for determining a minimum distance and the safety device with a distance sensor unit and an evaluation unit, reference is made to international patent application PCT/EP2021/054849, the content of which is hereby incorporated in its entirety into this application.

The method according to international patent application PCT/EP2021/054849 for determining a minimum distance of an object from an apparatus surface, in particular for determining a minimum distance of an object from an apparatus surface of a handling apparatus, comprises the following steps:
sensing a primary distance of the object by means of a first distance sensor unit positioned on or in the apparatus surface, wherein the primary distance is the distance of the object from the distance sensor unit,
determining a critical point which is at the primary distance from the first distance sensor unit and within a sensing range of the first distance sensor unit and comes closest to the apparatus surface in consideration of a 3-dimensional course of the apparatus surface, and
determining the minimum distance of the critical point from the apparatus surface.

Such a method can be performed simply and reliably. In this context, consideration is given to the fact that distance sensor units can typically determine a distance but cannot indicate where within the associated sensing range the distance is measured. This problem is solved by determining the critical point and the associated minimum distance. It is impossible for the method to determine a minimum distance which, e.g. owing to a 3-dimensional course of the apparatus surface, is greater than an actual distance. Rather, a somewhat shorter distance is output in case of doubt. The method is thus particularly safe.

In this context, the robot assembly in accordance with the invention has an apparatus surface. More specifically, the apparatus surface is designed as a surface of the protection element which comprises the fastening interface for the distance sensor unit.

The robot assembly in accordance with the invention can also be designed as a handling apparatus in terms of international patent application PCT/EP2021/054849.

The following items of information must be known for the method: course of the apparatus surface at least in the relevant range, position of the distance sensor unit on the apparatus surface, sensing range of the distance sensor unit. This information can easily be stored in a control unit which is configured for performing the method. It is also understood that a sensing range of a distance sensor unit is always selected such that the apparatus surface does not screen it. Otherwise, the distance sensor unit could not be operated with the desired reliability.

The safety device according to international patent application PCT/EP2021/054849 is suitable for a handling apparatus having an apparatus surface, in particular for a robot or robot assembly having an apparatus surface. The safety device comprises a first distance sensor unit which can be positioned on or in the apparatus surface, i.e. on a surface of the protection element, and an evaluation unit which is coupled by signal technology to the distance sensor unit and is designed to carry out the method according to international patent application PCT/EP2021/054849 when the distance sensor unit is in the mounted state. Minimum distances of apparatus surfaces, i.e. of a surface of the protection element, can thus be determined in a simple and reliable manner by means of the safety device. As a result, apparatuses equipped with the safety device, e.g. the inventive robot assembly and in particular handling apparatuses, can be operated reliably in such working spaces, in which objects which are potentially at risk of collision, and in particular also people, are present.

In one variant, the protection element is rod-shaped and has a first end and a second end. The second end is opposite the first end. The protection element is fastened via the first end to the manipulator unit and/or to the effector unit. The fastening interface for fastening a sensor unit is provided in the region of the second end. This means that the fastening interface is closer to the second end than to the first end. Of course, this includes the special case that the fastening interface is arranged directly at the second end. In other words, the protection element is in the form of a sensor or an antenna, wherein the fastening interface for fastening a sensor unit is positioned in the region of a sensor tip or antenna tip. Such protection elements can be referred to as protection sensors or protection antennas. Therefore, this results in a particularly favourable sensing range for a sensor unit which is mounted on the fastening interface. This sensing range includes in particular those portions of the effector unit which are designed to interact with a workpiece and, if applicable, the workpiece. Collision protection is thus particularly reliable and precise.

It is understood that the robot assembly can always also comprise a plurality of protection elements. In particular, two or more rod-shaped protection elements can be provided.

In another variant, the protection element is sleeve-shaped or sleeve portion-shaped. The protection element runs completely or partially around an outer circumference of the effector unit. In other words, the protection element is formed as a completely or partially circumferential collar. It can thus be referred to as a protection collar. “Runs around” is to be understood as “running around” with respect to the flange surface central axis. Therefore, this results in a particularly favourable sensing range for a sensor unit which is mounted on the fastening interface of the protection element. The same applies if the protection element is monitored by sensors.

The protection element can comprise a synthetic material.

In the event that the protection element is sleeve-shaped or sleeve portion-shaped, it can comprise a support structure which is provided with a covering. The support structure can comprise a synthetic material. The covering can likewise comprise a synthetic material. It is also possible for the covering to comprise a textile material.

At least two fastening interfaces for fastening a respective sensor unit for collision protection can be provided on or adjacent to an edge of the protection element facing away from the flange surface. The protection element is thus designed to carry at least two sensor units. Consequently, the effector unit and a workpiece which may be interacting therewith can be monitored by sensors with particular reliability and precision for the purpose of collision protection.

In one embodiment, the protection element has at least one opening. For example, a central axis of the at least one opening extends substantially radially with respect to the flange surface central axis. The at least one opening is preferably designed so that a person can look therethrough. Therefore, the effector unit and a workpiece which may be cooperating therewith can be observed if required. More preferably, the opening is restricted in size or shaped in such a way that a person cannot reach through the opening. The protection element thus constitutes protection against injury.

It is also possible for at least portions of the protection element to be transparent. Also, in this way a person can observe the effector unit and a workpiece which may be cooperating therewith.

In one alternative, at least a portion of the protection element is movable along the flange surface central axis. This portion can thus assume different positions along the flange surface central axis. In other words, this portion is displaceable along the flange surface central axis. Preferably, the fastening interface for fastening a sensor unit for collision protection is provided on the movable portion. A sensor unit mounted thereon can thus sense different regions of a surrounding area in dependence upon the position of the portion of the protection element along the flange surface central axis. The sensing range can thus be adjusted in particular in dependence upon whether the effector unit is currently interacting, is to start interacting or is to stop interacting with a workpiece or whether there is no workpiece interaction. Particularly reliable collision protection can thus be achieved in all of these cases. In the event that the protection element is rod-shaped, this rod can be extended and retracted. For example, the protection element is designed to be telescopic for this purpose. In the event that the protection element is sleeve-shaped or sleeve portion-shaped, the sleeve or sleeve portion can be extended and retracted. In this case also, the protection element can be designed to be telescopic.

At least a portion of the protection element can also be rotatable about at least a portion of the effector unit in relation to the flange surface central axis. The portion of the protection element can thus be rotated completely or partially around an outer circumference of the effector unit. For this purpose, the portion of the protection element can be mounted on an arcuate or ring-shaped rail. Such mobility makes it possible to protect a particularly large region of an area surrounding the effector unit with regard to possible collisions using a single protection element and a sensor unit possibly fastened thereto.

The protection element can comprise at least one portion consisting of an elastically deformable material. Such a protection element can work tactilely. This means that it is designed to come into contact with objects in the area surrounding the robot assembly, workpieces and also people for the purpose of collision protection. By reason of the elastically deformable material, at least a portion of the protection element deforms as soon as force or moment-loaded contact occurs between the protection element and another object, workpiece or person. By reason of this deformation, at least a portion of the protection element changes its spatial position. This is monitored by sensors. It is noted that the particular portion of the protection element, of which the change in spatial position is monitored by sensors can, but does not have to, coincide with the portion consisting of elastically deformable material. The portion of the protection element which is monitored by sensors with regard to its spatial position can thus also be designed to be rigid compared to the portion consisting of elastically deformable material. By monitoring the deformation, a collision with the effector unit can therefore be prevented. Such collision monitoring is simple and robust. In particular, sensor units used for collision protection can thus be mounted at positions which are exposed to a comparatively little extent.

It is possible for a deformation sensor unit to be positioned on the manipulation unit or on the effector unit. This is designed to detect a deformation of the portion consisting of elastically deformable material. As already explained, reliable collision protection can also be achieved in this manner.

In one design variant, the protection element in the non-deformed state protrudes along the flange surface central axis on a side, facing away from the flange surface, with respect to the effector unit. This is particularly the case in a view perpendicular to the flange surface central axis. In such a configuration, the protection element thus always contacts an object, a workpiece or a person first. Only after a certain deformation of the protection element can the effector unit contact the object, the workpiece or the person. Undesirable collisions can thus be reliably avoided.

Moreover, the effector unit can comprise a movement unit or can be coupled to the manipulator unit via a movement unit, and so at least a portion of the effector unit can be selectively moved out of an area surrounding the protection element. Therefore, the effector unit can adopt two states. In a first state, it is in an area surrounding the protection element and is therefore protected with regard to undesired collisions by means of the protection element. In a second state, the effector unit is outside the area surrounding the protection element and therefore is at least no longer completely protected by means of the protection element with regard to undesired collisions. The effector unit can thus be selectively transferred to a less well-protected state. It can be used e.g. to pick up a workpiece.

In addition, the object is achieved by a protection element for a robot assembly in accordance with the invention. The protection element comprises a mounting portion for fastening the protection element to a manipulator unit and/or to an effector unit of the robot assembly. Furthermore, the protection element has a cantilever portion which is designed to extend laterally next to at least one portion of the effector unit. A fastening interface is also provided on the cantilever portion for fastening a sensor unit for collision protection. Alternatively, at least a portion of the cantilever portion can be monitored by sensors for collision protection. The cantilever portion thus projects over at least a part of the effector unit in relation to the flange surface. This allows a sensor unit to be mounted in a comparatively exposed location. Alternatively, a comparatively exposed portion of the protection element can be sensed by sensors and so comparatively simple but reliable collision protection for the effector unit can be accomplished by means of the protection element.

The cantilever portion can be rod-shaped, sleeve-shaped or sleeve portion-shaped. By means of a cantilever formed in this manner, a region of an area surrounding an effector unit located at an end of the effector unit facing away from the flange surface can be reliably protected with regard to undesired collisions.

Furthermore, a portion of the protection element can be movable along the flange surface central axis. The length of the protection element can thus be adjusted along the flange surface central axis. In this way, a sensing range of a sensor unit mounted on the protection element can be adjusted easily and reliably. Alternatively, the detection range of a protection element which can be monitored by sensors can be easily adapted. Both enable reliable and flexible collision protection.

It is also possible for a portion of the protection element to be rotatable about at least a portion of the effector unit in relation to the flange surface central axis. This makes it possible to protect a large region of an area surrounding the effector unit with regard to possible collisions.

Alternatively or additionally, the protection element comprises at least one portion consisting of elastically deformable material. A deformation of the portion consisting of elastically deformable material can be monitored by sensors. Consequently, the portion of the protection element deforms as soon as force or moment-loaded contact occurs between the protection element and another object, workpiece or person. This constitutes simple and robust collision monitoring.

Furthermore, the effects and advantages already explained in connection with the robot assembly apply in an analogous manner to the protection element.

Moreover, the object is achieved by a protection assembly comprising an inventive protection element and a distance sensor unit. The distance sensor unit is fastened to the fastening interface of the protection element. Consequently, the distance sensor unit can also be used to determine distances and prevent undesired collisions with high reliability and precision, even in a region around an end of an effector unit facing away from a flange surface.

As already explained in connection with the robot assembly in accordance with the invention, the distance sensor unit can be a distance sensor unit of a safety device according to international patent application PCT/EP2021/054849. It can be coupled by signal technology to an evaluation unit of the safety device from international patent application PCT/EP2021/054849. Therefore, a method for determining a minimum distance according to international patent application PCT/EP2021/054849 can be used in order to determine distance by means of the distance sensor unit. In connection with the protection assembly, reference is also made to international patent application PCT/EP2021/054849, the content of which is hereby incorporated in its entirety into this application.

The invention will be explained hereinafter with the aid of various exemplified embodiments which are illustrated in the attached drawings. In the figures:

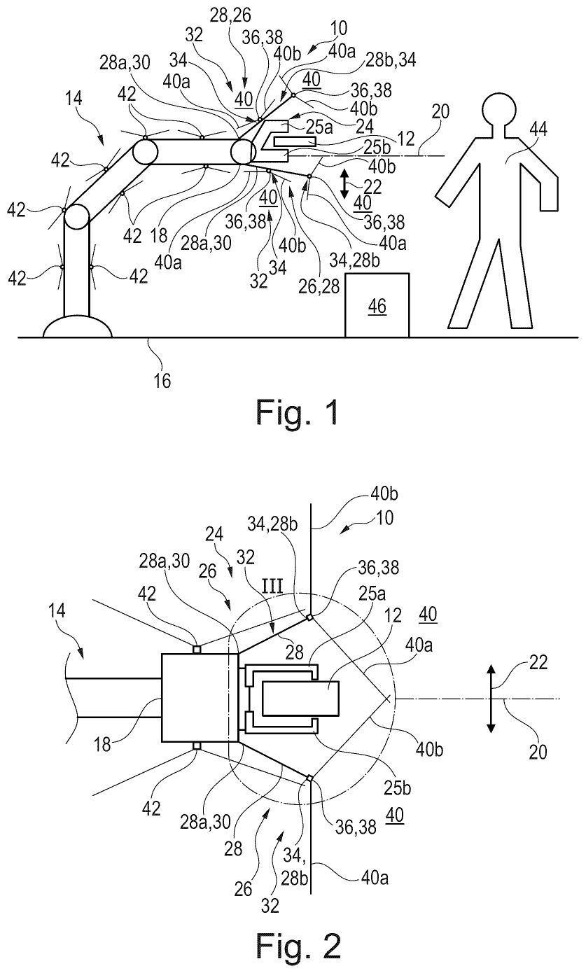

FIG. 1 shows schematically a robot assembly in accordance with the invention comprising two protection assemblies in accordance with the invention which each comprise a protection element in accordance with the invention according to a first embodiment,

FIG. 2 shows schematically a portion of a further robot assembly in accordance with the invention comprising two protection assemblies in accordance with the invention which each comprise a protection element in accordance with the invention according to a second embodiment,

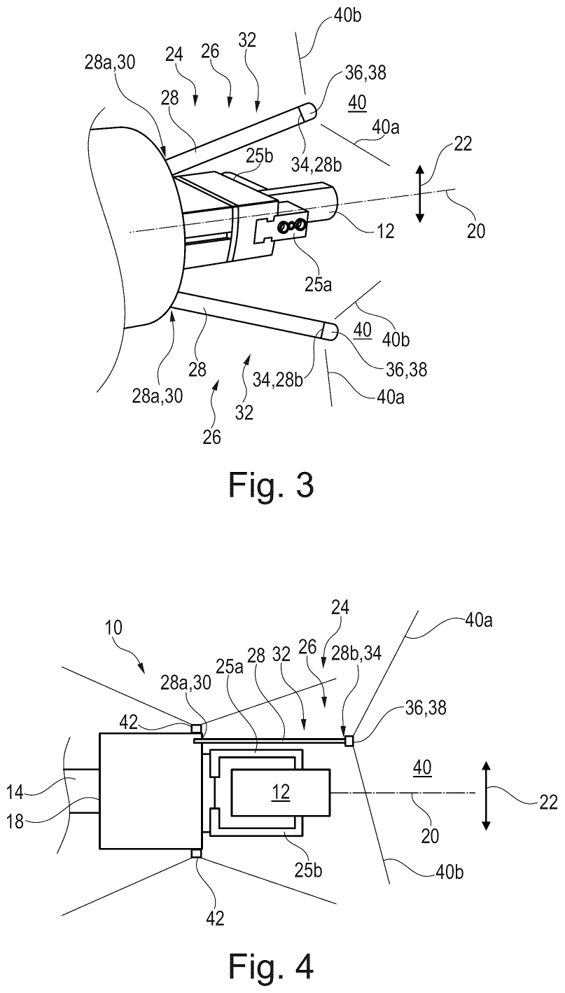

FIG. 3 shows a perspective view of a portion III of the robot assembly of FIG. 2,

FIG. 4 shows schematically a portion of another robot assembly in accordance with the invention comprising a protection assembly in accordance with the invention which comprises a protection element in accordance with the invention according to a third embodiment,

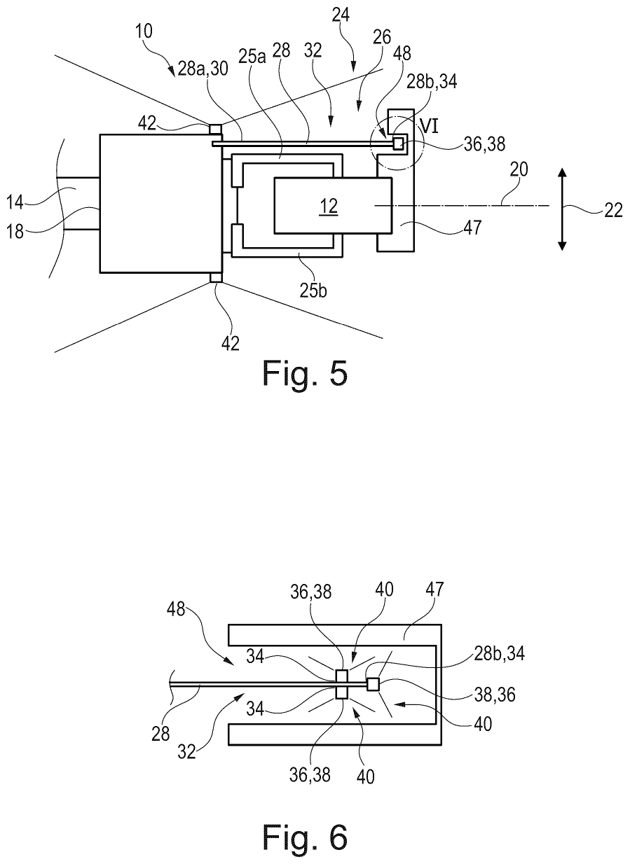

FIG. 5 shows the portion of the robot assembly of FIG. 4 in another operating state,

FIG. 6 shows a detail VI of FIG. 5,

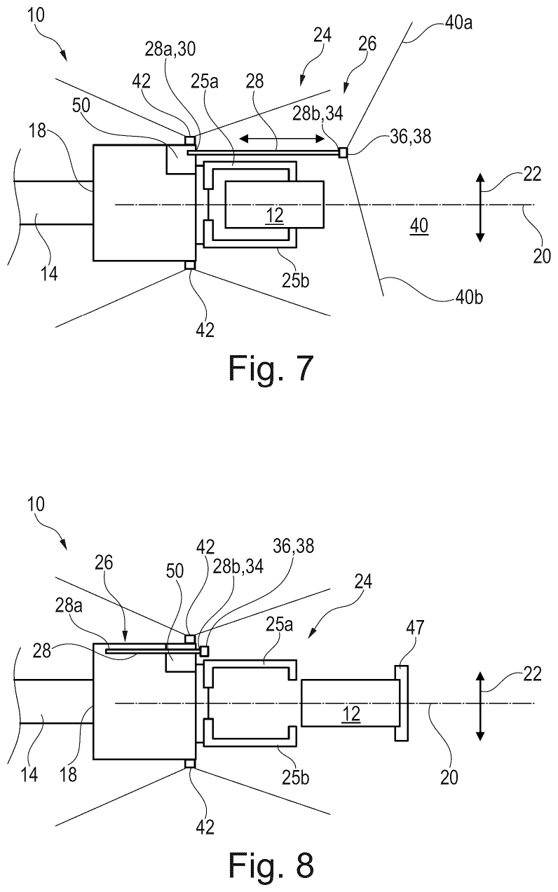

FIG. 7 shows schematically a portion of another robot assembly in accordance with the invention comprising a protection assembly in accordance with the invention which comprises a protection element in accordance with the invention according to a fourth embodiment,

FIG. 8 shows the portion of the robot assembly of FIG. 7 in another operating state,

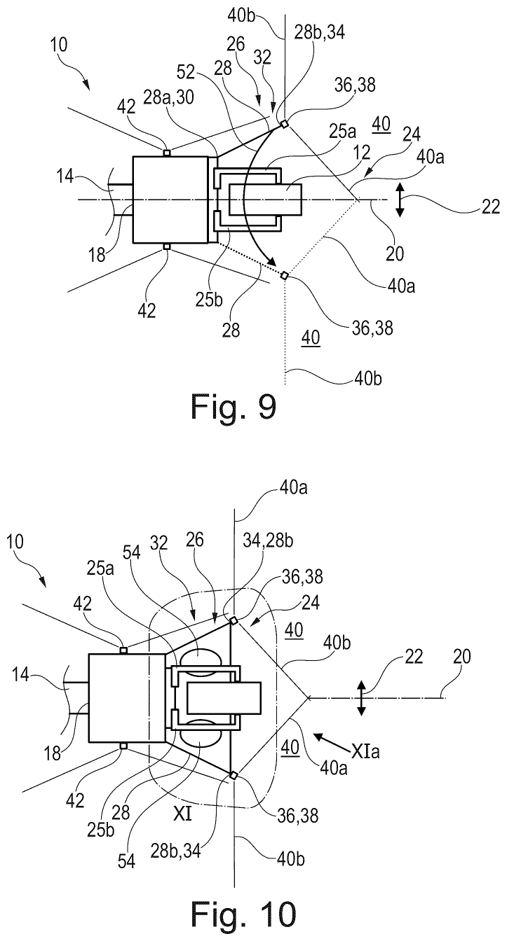

FIG. 9 shows schematically a portion of a further robot assembly in accordance with the invention comprising a protection assembly in accordance with the invention which comprises a protection element in accordance with the invention according to a fifth embodiment,

FIG. 10 shows schematically a portion of a further robot assembly in accordance with the invention comprising a protection assembly in accordance with the invention which comprises a protection element in accordance with the invention according to a sixth embodiment,

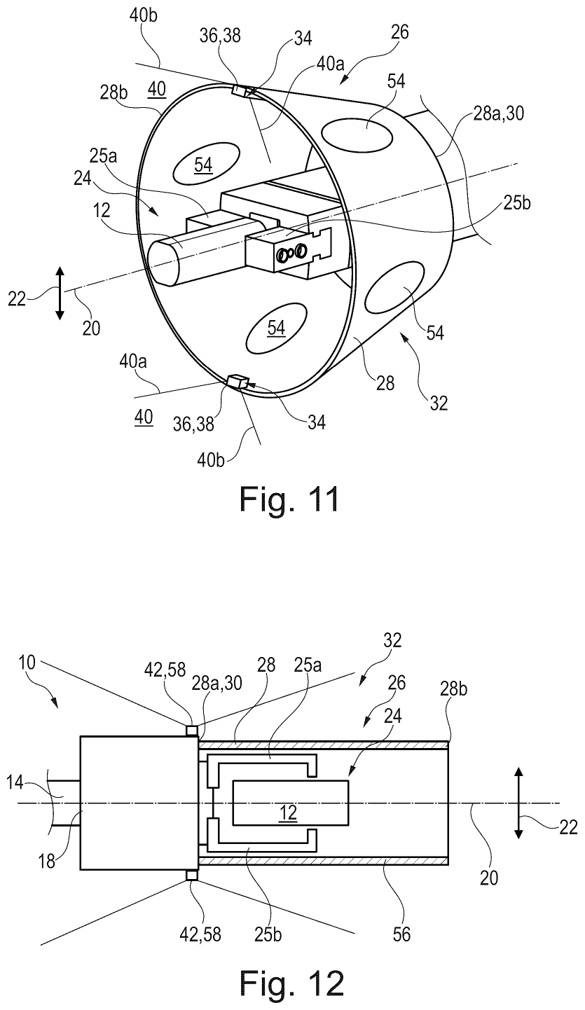

FIG. 11 shows a perspective view of a portion XI of the robot assembly of FIG. 10 viewed in a direction XIa in FIG. 10,

FIG. 12 shows schematically a portion of a further robot assembly in accordance with the invention comprising a protection assembly in accordance with the invention which comprises a protection element in accordance with the invention according to a seventh embodiment,

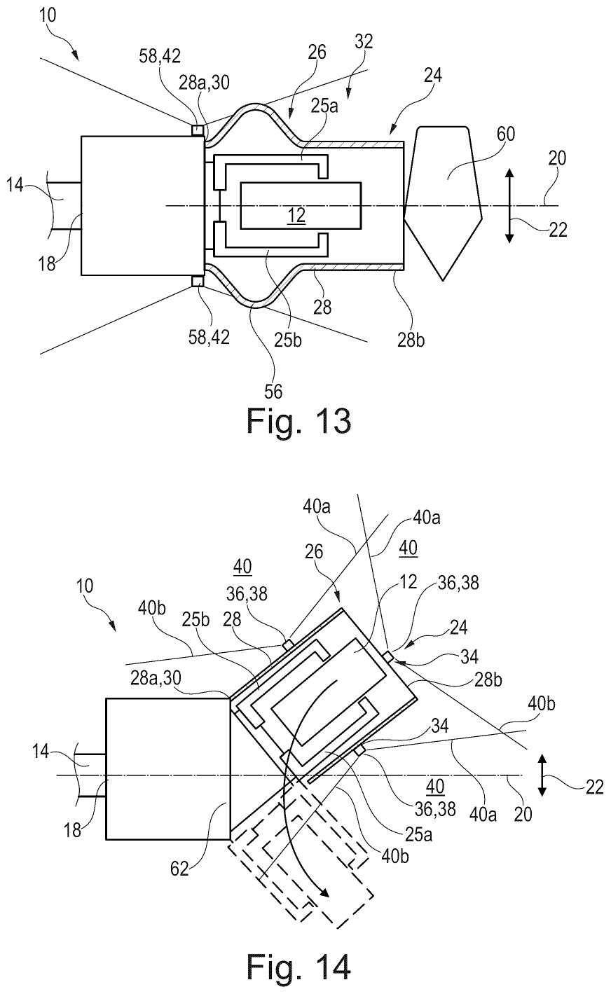

FIG. 13 shows the portion of the robot assembly of FIG. 12 in another operating state, and

FIG. 14 shows schematically a portion of a further robot assembly in accordance with the invention comprising a protection assembly in accordance with the invention which comprises a protection element in accordance with the invention according to an eighth embodiment.

FIG. 1 shows a robot assembly 10 which is designed to handle a workpiece 12. The workpiece 12 can thus be transferred from a first position to a second position by means of the robot assembly 10.

For this purpose, the robot assembly 10 comprises a manipulator unit 14 which, in the illustrated embodiment, is designed as a robot arm of an industrial robot.

In the illustrated example, a first end of the manipulator unit 14 is fixed on a floor 16. A flange surface 18 is provided at a second end of the manipulator unit 14 which is opposite the first end.

A flange surface central axis 20 is perpendicular to the flange surface 18.

A flange surface transverse direction 22 extends in parallel with the flange surface 18 and perpendicularly to the flange surface central axis 20, as shown by a double arrow.

An effector unit 24 is mounted on the flange surface 18 and, in the illustrated example, is designed as a gripper unit for gripping the workpiece 12. It comprises two schematically illustrated gripping arms 25a, 25b.

The effector unit 24 has an extension component along the flange surface central axis 20 and an extension component in the flange surface transverse direction 22.

Furthermore, the robot assembly 10 comprises a protection assembly 26. More precisely, the robot assembly 10 of FIG. 1 comprises two protection assemblies 26.

Each of the protection assemblies 26 comprises a protection element 28 which is rod-shaped.

The protection elements 28 also have an extension component along the flange surface central axis 20. In the illustrated embodiment, an extension component along the flange surface central axis 20 is larger than an extension component in the flange surface transverse direction 22.

Each of the protection elements 28 has, at a first end 28a, a mounting portion 30, via which it is fastened to the manipulator unit 14 in the illustrated embodiment.

In addition, each of the protection elements 28 has a cantilever portion 32 which in each case extends laterally next to at least a portion of the effector unit 24. In other words, at least portions of the protection elements 28 are positioned in the flange surface transverse direction 22 next to the effector unit 24.

In FIG. 1, one of the cantilever portions 32 extends above the effector unit 24 and one of the cantilever portions 32 extends below the effector unit 24.

Therefore, both cantilever portions 32 project over the effector unit 24. In the illustrated embodiment, the cantilever portions 32 also project over the workpiece 12.

Two fastening interfaces 34 are provided on each of the cantilever portions 32 for fastening an allocated sensor unit 36 for collision protection.

In the illustrated embodiment, the sensor units 36 are designed as distance sensor units 38.

A distance sensor unit 38 is thus fastened to each of the fastening interfaces 34.

The associated sensing ranges 40 of the distance sensor units 38 are each indicated by two thin boundary lines 40a, 40b. It is understood that the sensing ranges 40 are conical in reality.

It is directly apparent from FIG. 1 that the sensing ranges 40 of the distance sensor units 38 positioned at a second end 28b of the protection elements 28 extend onto a side of the effector unit 24 facing away from the flange surface 18. The second end 28b is opposite the first end 28a. Therefore, it is also possible to sense distances along the flange surface central axis 20 in front of the effector unit 24.

In the embodiment shown in FIG. 1, a workpiece 12 is picked up by the effector unit 24. The sensing ranges 40 also extend onto a side of the workpiece 12 facing away from the flange surface 18.

A plurality of distance sensor units 42 are also mounted on the manipulator unit 14.

The distance sensor units 38 and the distance sensor units 42 are each connected by signal technology to a control unit, not illustrated in greater detail.

The distance sensor units 38, 42 are designed to determine distances between components of the robot assembly 10 and people 44 and further objects 46 which are located in the working region of the robot assembly 10.

If these distances are known, a movement of the robot assembly 10 can be slowed down, adjusted in direction, stopped or completely prevented by means of the control unit such that no undesired collisions of components of the robot assembly 10 with the person 44 and/or the object 46 take place.

In other words, collision protection of the robot assembly 10 can be accomplished by means of the distance sensor units 38, 42.

As already mentioned, a method according to international patent application PCT/EP2021/054849 can be used for this purpose.

FIGS. 2 to 3 show a portion of a further robot assembly 10.

Only the differences from the embodiment shown in FIG. 1 will be discussed hereinafter. Identical or mutually corresponding components are designated by the same reference signs.

In contrast to the robot assembly 10 of FIG. 1, a different effector unit 24 is now used.

The two protection assemblies 26 comprising the protection elements 28 and the distance sensor units 38 are now fastened to the effector unit 24 via the respective mounting portions 30.

Furthermore, two further distance sensor units 42 are now also provided on the effector unit 24.

Another robot assembly 10 can be seen in FIGS. 4, 5 and 6.

This will again be described based on the embodiments already explained. Identical or mutually corresponding components are again designated by the same reference signs.

In contrast to the previous exemplified embodiments, only one single protection assembly 26 is now provided.

The associated protection element 28 extends substantially along the flange surface central axis 20. Therefore, it has essentially no extension component in the flange surface transverse direction 22.

Otherwise, the effector unit 24 is essentially identical to the effector unit 24 of FIGS. 2 and 3. Only the distance sensor units 42 are positioned slightly differently.

In the embodiment shown in FIGS. 4 to 6, the distance sensor units 38, 42 are used as usual for collision protection.

In addition, the distance sensor unit 38 is used to be able to teach a specified pick-up position for picking up the workpiece 12 and to approach it reliably during operation. This is particularly advantageous when a position of the workpiece 12 is subject to fluctuation or is only approximately known.

For this purpose, a reference contour 48 is provided on a workpiece carrier 47, from which the workpiece 12 is to be removed, said reference contour being able to be sensed by means of the distance sensor unit 38. This ensures that the workpiece 12 is picked up at the designated location by means of the effector unit 24.

FIG. 6 shows in this context a variant in which a total of three distance sensor units 38 are arranged on the protection element 28 and so the effector unit 24 can be oriented with high precision with respect to the workpiece 12. In addition or as an alternative to one of the three distance sensor units 38, a force sensor unit can be provided.

FIGS. 7 and 8 show a further robot assembly 10, for which again only the differences compared to the already explained embodiments are explained. As usual, identical or mutually corresponding components have the same reference signs.

In the embodiment shown in FIGS. 7 and 8, the protection element 28, to which a distance sensor unit 38 is fastened, is displaceable along the flange surface central axis 20.

For this purpose, a displacement drive 50 is provided, which is drivingly coupled to the protection element 28.

By means of the displacement drive 50, the protection element 28 can thus be moved back and forth along the flange surface central axis 20. For example, the protection element 28 can be withdrawn from the workpiece carrier 47 in order to pick up and place down a workpiece 12 (see in particular FIG. 8). This produces a sufficiently large free space for the interaction of the effector unit 24 with the workpiece 12.

The distance sensor unit 38 fastened to the protection element 28 can also be selectively deactivated. Therefore, the workpiece 12 is not detected as an object potentially at risk of collision.

FIG. 9 shows yet another robot assembly 10, for which again only the differences compared to the already explained embodiments are explained. As usual, identical or mutually corresponding components have the same reference signs.

The robot assembly 10 of FIG. 9 has a single protection assembly 26. The protection element 28 extends along the flange surface central axis 20 and in the flange surface transverse direction 22.

The protection element 28 is also rod-shaped and has, at its second end, a fastening interface 34, on which a distance sensor unit 38 is mounted.

In the embodiment shown in FIG. 9, the protection element 28 can now be rotated about the effector unit 24 in relation to the flange surface central axis 20. This is illustrated by the arrow 52 and an alternative position of the protection element 28 and the distance sensor unit 38 as shown by dashed lines. However, it is understood that the protection element can be rotated steplessly with the distance sensor unit 38. In addition to the positions illustrated in FIG. 9, intermediate positions can also be assumed.

By rotating the protection element 28 with the distance sensor 38 about the flange surface central axis 20, an area surrounding the effector unit 24, which is located at an end of the effector unit 24 facing away from the flange surface 18, can be scanned for possible obstacles.

FIGS. 10 and 11 illustrate another robot assembly 10. As usual, this is explained based on the preceding embodiments.

Identical or mutually corresponding components are designated by the same reference signs.

In contrast to the preceding embodiments, the protection element 28 is now sleeve-shaped. In the illustrated embodiment, it runs completely around an outer circumference of the effector unit 24.

In other words, the protection element 28 is designed as a protection collar.

The protection element 28, i.e. the protection collar, has a first end 28a, via which it is fastened to the effector unit 24.

A second end 28b is opposite the first end 28a. The second end 28b is thus formed by an edge of the protection element 28 facing away from the flange surface 18.

At the second end 28b, two fastening interfaces 34 are provided for fastening a respective sensor unit 36 for collision protection. As before, the sensor units 36 are designed as distance sensor units 38.

In addition, in the embodiment of FIGS. 10 and 11 the protection element 28 has a plurality of openings 54. During operation of the robot assembly 10, the effector unit 24 and a workpiece 12 possibly interacting therewith can be observed through these openings 54.

A further robot assembly 10 is shown in FIGS. 12 and 13.

In this variant also, the protection element 28 is sleeve-shaped and runs completely around an outer circumference of the effector unit 24.

The protection element 24 protrudes along the flange surface central axis 20 on a side, facing away from the flange surface 18, with respect to the effector unit 24.

Furthermore, in the variant of FIGS. 12 and 13, the protection element 28 is produced from an elastically deformable material 56.

No sensor units are fastened to the protection element 28 itself. Corresponding fastening interfaces are also not provided.

However, the sensor units 42 positioned on the effector unit 24 are designed to monitor a deformation of the protection element 28 by sensors. This means that a deformation of the protection element 28 can be recognised by means of the sensor units 42.

Accordingly, the sensor units 42 are deformation sensor units 58 in the present example.

The deformation sensor units 58 are designed as distance sensor units.

It can be seen in FIG. 13 how the protection element 28 is deformed by coming into contact with an object 60 and this deformation is detected by means of the deformation sensor unit 58.

A further robot assembly 10 is shown in FIG. 14.

The protection element 28 is now sleeve portion-shaped. In the illustrated embodiment, the protection element 28 runs only partially around the outer circumference of the effector unit 24.

The sleeve portion-shaped protection element 28 has the shape of a half shell.

However, the effector unit 24 now comprises a movement unit 62, via which a portion of the effector unit 24 can be selectively moved out of an area surrounding the protection element 28.

The portion of the effector unit 24 can thus adopt a first position in which it is partially enclosed by the protection element 28. In a second position, the portion of the effector unit 24 is not enclosed by the protection element 28.

The second position can be used e.g. if the effector unit is to pick up or place down a workpiece 12. The first position is used in all other cases.

In all embodiments, at least one distance sensor unit 38 is mounted in an exposed state by means of the protection element 28 such that objects 46 and/or people 44 located in a surrounding area portion at one end of the effector unit 24, which is opposite the flange surface 18, can be detected with a high degree of precision and reliability. This applies regardless of whether a workpiece 12 is gripped by the effector unit 24 or not. In other words, the at least one distance sensor unit 38 is mounted so that it can look around the effector unit 24 and possibly the workpiece 12.

As an alternative thereto, at least one portion of the protection element 28 is monitored by sensors and is mounted in an exposed state such that objects 46 and/or people 44 located in a surrounding area portion at one end of the effector unit 24, which is opposite the flange surface 18, can be detected with a high degree of precision and reliability. This can also be effected regardless of whether a workpiece 12 is gripped by the effector unit 24 or not. A deformation of the protection element 28 is determined by sensors.

### LIST OF REFERENCE SIGNS

10 robot assembly

12 workpiece

14 manipulator unit

16 floor

18 flange surface

20 flange surface central axis

22 flange surface transverse direction

24 effector unit

25a gripping arm

25b gripping arm

26 protection assembly

28 protection element

28a first end of the protection element

28b second end of the protection element

30 mounting portion

32 cantilever portion

34 fastening interface

36 sensor unit

38 distance sensor unit

40 sensing range

40a boundary line

40b boundary line

42 distance sensor unit

44 human/person

46 object

47 workpiece carrier

48 reference contour

50 displacement drive

52 arrow

54 opening

56 elastically deformable material

58 deformation sensor unit

60 object

62 movement unit

What is claimed is:

1. A robot assembly for processing and/or handling a workpiece, comprising:
a manipulator unit having a flange surface, wherein a flange surface central axis is perpendicular to the flange surface, and a flange surface transverse direction extends in parallel with the flange surface,
an effector unit which is mounted on the flange surface and has a first extension component along the flange surface central axis as well as a second extension component in the flange surface transverse direction, and
a protection element which is fastened to the manipulator unit and/or to the effector unit and has an third extension component along the flange surface central axis,
wherein the protection element is positioned at least in portions next to the effector unit in the flange surface transverse direction, and
wherein a fastening interface for fastening a sensor unit is provided on the protection element for collision protection or wherein the protection element can be monitored by sensors for collision protection.

2. The robot assembly as called for in claim 1, wherein at least one distance sensor unit is fastened to the fastening interface of the protection element, a sensing range of said at least one distance sensor unit extending onto a side of the effector unit facing away from the flange surface.

3. The robot assembly as claimed called for in claim 1, wherein the protection element is rod-shaped and has a first end as well as a second end which is opposite the first end, wherein the protection element is fastened via the first end to the manipulator unit and/or to the effector unit, and wherein the fastening interface for fastening the sensor unit is provided in a region of the second end.

4. The robot assembly as called for in claim 1, wherein the protection element is sleeve-shaped or sleeve portion-shaped and runs completely or partially around an outer circumference of the effector unit.

5. The robot assembly as called for in claim 4, wherein at least two fastening interfaces for fastening a respective sensor unit for collision protection are provided on or adjacent to an edge of the protection element facing away from the flange surface.

6. The robot assembly as called for in claim 4, wherein the protection element has at least one opening.

7. The robot assembly as called for in claim 1, wherein at least a portion of the protection element is movable along the flange surface central axis.

8. The robot assembly as called for in claim 1, wherein at least a portion of the protection element is rotatable about at least a portion of the effector unit in relation to the flange surface central axis.

9. The robot assembly as called for in claim 1, wherein the protection element comprises at least a portion consisting of elastically deformable material.

10. The robot assembly as called for in claim 9, wherein a deformation sensor unit is positioned on the manipulation unit or on the effector unit and is designed to detect a deformation of the portion consisting of the elastically deformable material.

11. The robot assembly as called for in claim 9, wherein the protection element in the a non-deformed state protrudes along the flange surface central axis on a side, facing away from the flange surface, with respect to the effector unit.

12. The robot assembly as called for in claim 1, wherein the effector unit comprises a movement unit or is coupled to the manipulator unit via the movement unit, and so at least a portion of the effector unit can be selectively moved out of an area surrounding the protection element.

13. A protection system for a robot assembly, comprising:
a manipulator having a flange surface, wherein a flange surface central axis is perpendicular to the flange surface, and a flange surface transverse direction extends in parallel with the flange surface,
an effector which is mounted on the flange surface and has a first extension component along the flange surface central axis as well as a second extension component in the flange surface transverse direction, and
a protector which is fastened to the manipulator and/or to the effector and has a third extension component along the flange surface central axis,
wherein the protector is positioned at least in portions next to the effector in the flange surface transverse direction, wherein a fastener for fastening a sensor is provided on the protector for collision protection or wherein the protector can be monitored by sensors for collision protection, and
a mounting connector for fastening the protector to the manipulator and/or to an the effector of the robot assembly, and a cantilever which is designed to extend laterally next to at least a portion of the effector, wherein the fastener for fastening the sensor unit for collision protection is further provided on the cantilever or wherein at least a portion of the cantilever can be monitored by the sensors for collision protection.

14. The protection system as called for in claim 13, wherein the cantilever is rod-shaped, sleeve-shaped or sleeve portion-shaped.

15. The protection system of claim 13, further comprising a distance sensor fastened to the fastener.
